(19) United States
(12) Patent Application Publication
(10) Pub. No.: US 2008/0114510 A1
(43) Pub. Date: May 15, 2008

(54) Method and Device for Detecting a Pending Collision

(75) Inventors: Ulf Wilhelm, Rutesheim (DE); Martin Randler, Immenstaad (DE); Ruediger Jordan, Stuttgart (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 11/662,981

(22) PCT Filed: Jul. 20, 2005
(86) PCT No.: PCT/EP05/53525

§ 371 Date: Jan. 16, 2008

(30) Foreign Application Priority Data
Sep. 30, 2004 (DE) 10 2004 048 191.1

(51) Int. Cl. G01S 13/93; B60R 22/195; B60R 21/01

(52) U.S. Cl. 701/41; 701/301

(57) ABSTRACT

A method and a device for transmitting and receiving electromagnetic radiation are provided to detect, within a future time period, a pending collision with a preceding object. The transmitted radiation is FMCW-modulated, the slope of the frequency ramp is determined as a function of the transmit frequency and as a function of the future time period, and a pending collision within the future time period is ascertained when a negative receive frequency is detected.

### BACKGROUND OF THE INVENTION

1. Field of the Invention

The present invention relates to a method and a device for transmitting and receiving electromagnetic radiation to detect a pending collision with a preceding object within a future time period, the transmitted radiation being FMCW-modulated.

2. Description of Related Art

A radar sensor system which emits FMCW-modulated radiation and receives partial radiation reflected by preceding objects is described in “Adaptive Cruise Control (ACC)”, published by Robert Bosch GmbH, April 2002 (ISBN-3-7782-2034-9). If a preceding object is detected, the speed of the motor vehicle equipped with this device is regulated, this regulation being carried out in the manner of a constant-distance regulation. If no preceding object recognized as a vehicle traveling ahead is detected, a speed regulation in the manner of a constant-speed regulation to a setpoint velocity specified by the driver is carried out. The transmitted radar radiation in this case is emitted via frequency ramps in an FMCW (Frequency-Modulated Continuous Wave)-modulated manner, and the distance and relative velocity of the preceding object are ascertained as a function of the Doppler shift in the transmitted radiation as well as the propagation time of the transmitted radiation. The signal propagation time is calculated as τ=2d/c and the Doppler effect is specified according to the following equation:

$${f}_{D} = - \frac{2 {f}_{C} * {v}_{rel}}{c}$$

### A BRIEF SUMMARY OF THE INVENTION

An object of the present invention is to provide a method and a device in which the transmit frequency and the slope of the frequency ramps are adjusted to each other in such a way that a collision with a preceding object within a predetermined time period t_{TC} is ascertained by detecting a negative receive frequency.

The future time period within which a collision is detectable is advantageously the time period in which a safety means to be activated and/or a safety function to be activated must be activated prior to the ascertained time of collision.

Furthermore, it is advantageous that a quadrature receiver is provided to detect negative frequencies.

It is particularly advantageous that the quadrature receiver has a phase comparator which uses the phase relation between the in-phase signal and the quadrature signal to determine whether the received frequency is a positive or a negative frequency.

A safety means and/or a safety function is advantageously activated when a negative frequency is detected. This safety means may be, for example, an occupant restraining means in the form of a seat belt tensioner or an airbag. The safety function may be, for example, automatically initiated and carried out emergency braking of the vehicle and/or automatic steering intervention to avoid a collision or to reduce the intensity of the collision.

Furthermore, it is advantageous that the safety means and/or safety function is at least one automatic vehicle deceleration, one automatic steering intervention, the activation of at least one occupant restraint system or a combination thereof.

The transmitted and received electromagnetic radiation is advantageously microwave radiation in the form of a radar signal or a laser beam which detects objects present in the area ahead of the vehicle.

Furthermore, it is advantageous that a frequency ramp having an appropriate slope is provided to activate multiple safety means and/or safety functions for any period of time in which the safety means and/or safety function must be activated prior to the ascertained collision time. If more than one safety means and/or safety function is activated, the period of time in which the safety means must be activated before a possible collision is dependent on the type of safety means. In the case of a belt tensioner, which tightens the seatbelt of the vehicle occupant prior to a collision, this is, for example, the amount of time the belt tensioner needs to tighten the belt. In the case of airbags, this may be, for example, the amount of time needed to inflate the airbag prior to the time of collision to provide an optimum protective function. In the case of automatic vehicle decelerations and/or automatic steering interventions, this period of time may be predetermined, for example, by dynamic vehicle variables. Because the future time periods in which the safety means or safety function must be activated prior to the ascertained time of collision vary depending on the safety means activated, and the transmit frequency of the transmitted signal as well as the ramp slope of the modulated transmit signal must be adjusted to this time, it is advantageous that a separate frequency ramp is provided for each different time period if multiple safety means or safety functions are to be activated. Forms of FMCW modulation in which frequency ramps having different slopes are transmitted and received successively may be suitable for this purpose.

Another possibility is for the future time period within which a collision is detectable to be the time period in which a safety means to be activated and/or a safety function to be activated must be activated prior to the ascertained time of collision.

It is also advantageous that the received signals are supplied to a quadrature receiver to detect negative frequencies.

It is particularly advantageous that a phase comparator determines on the basis of the phase relation between the in-phase signal and the quadrature signal whether the received frequency is a positive or a negative frequency.

Upon detection of a negative frequency, a safety means and/or a safety function is/are advantageously activated.

Furthermore, it is advantageous that at least one automatic vehicle deceleration, one automatic steering intervention, the activation of at least one occupant restraint system or a combination thereof is activated as the safety means and/or safety function.

A frequency ramp having an appropriate slope is advantageously provided within the FMCW-modulated transmit signal to activate multiple safety means and/or safety functions for any period of time in which the safety means and/or safety function must be activated prior to the ascertained time of collision.

Implementation of the method according to the present invention in the form of a control element which is provided for a control unit of an adaptive distance and cruise control system of a motor vehicle is of particular significance. In this case, a program which is executable on an arithmetic unit, in particular on a microprocessor or signal processor, and is suitable for carrying out the method according to the present invention, is stored on the control element. In this case, therefore, the present invention is implemented by a program stored on the control element. In particular, an electrical memory medium, for example a read-only memory, may be used as the control element.

### BRIEF DESCRIPTION OF THE SEVERAL VIEWS OF THE DRAWING

FIG. 1 shows a block diagram of a first example embodiment of the device according to the present invention.

FIG. 2 shows a block diagram of a second example embodiment of the device according to the present invention.

FIG. 3 shows a frequency-time diagram of the transmit and receive signals.

FIG. 4 shows a relative velocity-distance diagram for the purpose of illustrating the present invention.

### DETAILED DESCRIPTION OF THE INVENTION

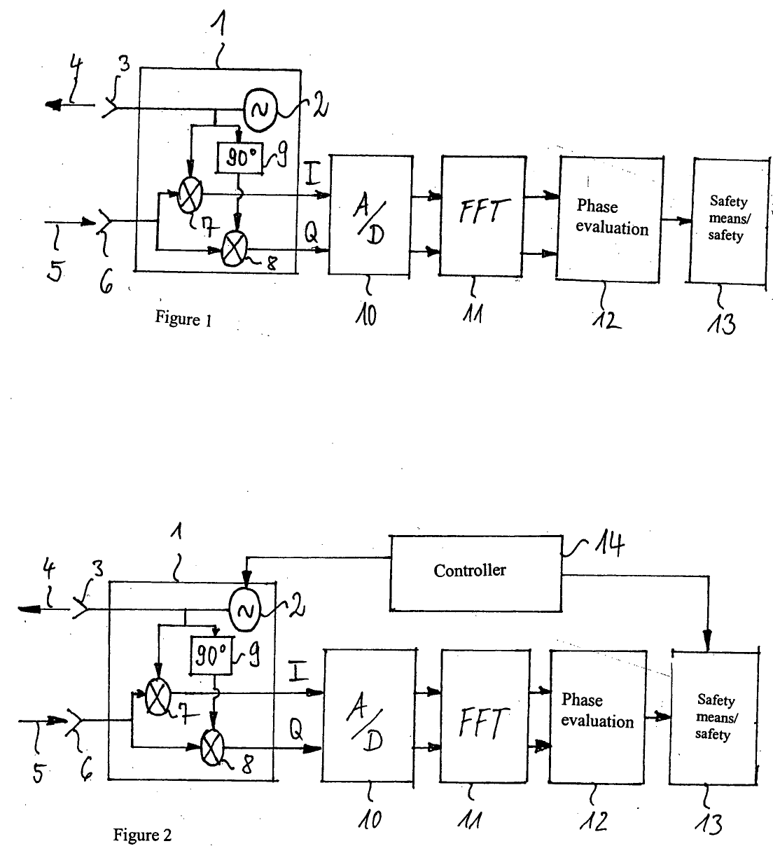

FIG. 1 shows a schematic block diagram illustrating a high-frequency transceiver 1. This high-frequency transceiver 1 includes a high-frequency oscillator 2 which generates a high-frequency microwave radiation as a function of a control voltage signal supplied thereto. Oscillator 2 forwards this microwave radiation to a transmit antenna 3 which emits the microwave signal in the form of transmit signal 4. This transmit signal 4 is reflected by objects located in front of the motor vehicle equipped with the system according to the present invention and returned in the form of receive signal 5. Receive signal 5 is time-shifted in relation to transmit signal 4 as a result of the signal propagation time and its frequency is also Doppler-shifted due to the relative velocity of the reflecting object. If transmit signal 4 emits an FMCW-modulated signal which has time-linear frequency variations in the form of frequency ramps, a receive signal 5 is produced which has a different frequency in relation to transmit signal 4. This frequency variation is produced by the Doppler effect as a result of the relative velocity of the reflecting object and, in the event of a rising frequency ramp of transmit signal 4, the instantaneous frequency of transmit signal 4 is already varied due to the fact that the instantaneous receive signal was emitted at a different frequency as a result of the signal propagation time. Receive signal 5 is received by a receive antenna 6 and supplied to mixers 7, 8. According to the present invention, this transceiver may be designed not as illustrated as a bistatic transceiver system using separate antennas for transmitting and receiving, but rather as a monostatic system using the same transceiver antenna to transmit and receive signals 4, 5. An additional duplexer filter which directs the output signal of oscillator 2 to the monostatic antenna and forwards the receive signals of the monostatic antenna to mixer 7, 8 may be inserted in this case. The exemplary embodiment illustrated in FIG. 1 includes a quadrature receiver, which is why two separate receive channels are provided for in-phase signal I and quadrature signal Q. Receive signal 5 received via receive antenna 6 is forwarded to in-phase mixer 7, to which the output signal of oscillator 2 is also supplied. In-phase mixer 7 demodulates receive signal 5 via instantaneous transmit signal 2 and generates in-phase signal I therefrom, which is output to analog-digital converter unit 10. In addition, receive signal 5 is forwarded from receive antenna 6 to quadrature mixer 8, to which the output signal of oscillator 2 is also supplied, but which is additionally phase-shifted by 90° or π/2 by phase shifter 9. Quadrature mixer 8 uses the signals supplied to it to generate a quadrature output signal Q, which is likewise supplied to analog-digital converter unit 10. Because, as a result of a time-variable frequency ramp, which varies the transmit frequency during propagation time τ of the signal in relation to transmit signal 4, receive signal 5 is varied by the frequency

$${f}_{LZ} = \frac{2 \cdot Slope \cdot d}{c} \qquad ( Eq . 1 )$$

and this signal is also varied by the following value as a result of the Doppler effect,

$${f}_{D} = \frac{2 \cdot {f}_{t} \cdot v}{c} \qquad ( Eq . 2 )$$

this results in an instantaneous frequency for the receive signal of:

$${f}_{r} = {f}_{LZ} + {f}_{D} = \frac{2 \cdot Slope \cdot d}{c} + \frac{2 \cdot {f}_{t} \cdot v}{c} \qquad ( Eq . 3 )$$

where Slope is the frequency variation per time unit of the ramp slope of the FMCW-modulated signal; d is the distance from the object to the host vehicle; fₜ is the emitted frequency; v is the relative velocity of the reflecting object in relation to the host vehicle; and c is the speed of light. To detect negative frequencies on the basis of this equation, fᵣ≦0 must be set, after which the equation can be converted to

$$\frac{d}{- v} = \frac{{f}_{t}}{Slope} = {t}_{TC} \qquad ( Eq . 4 )$$

which corresponds exactly to time t_{TC} until a future collision, provided that the objects continue to move at relative velocity v, based on instantaneous distance d. If the time period until a future collision t_{TC} is selected in such a way that this time period corresponds to the amount of time needed to activate a safety means, for example t_{TC}=0.3 seconds, the collision may be ascertained by detecting a negative receive frequency fᵣ, provided that the quotient fₜ/Slope, i.e., the transmit frequency divided by the ramp slope, is set to a value equal to time period t_{TC}. For example, if transmit frequency fₜ=77 GHz is set, and if t_{TC}=0.3 seconds is required for the time period needed to activate a safety means or safety function, a necessary ramp slope of “Slope”=257 GHz/second is obtained for this purpose. In the embodiment described, therefore, if a transmit frequency fₜ=77 GHz and a ramp slope of “Slope”=257 GHz/second are set, a future collision within future time period t_{TC}=0.3 seconds is ascertainable if negative receive frequency fᵣ is detected. This numerical example may also be transformed to other time periods needed to activate safety means, either ramp slope “Slope” or transmit frequency fₜ having to be adjusted in relation to time period t_{TC} for this purpose. If time period t_{TC}=0 seconds is selected, this device may be used to ascertain whether a collision is beginning at this moment. Receive signals I and Q digitized by analog-digital converter 10 are supplied to a Fourier transformation device 1 in which the digitized receive data is converted to a frequency spectrum and subsequently supplied to a phase evaluation device 12. In detecting positive receive frequencies fᵣ>0, the in-phase signals have a 90° phase relation with regard to the quadrature signals due to phase shifter 9 via which the demodulation signal of the quadrature channel was shifted. If a collision-critical object is detected, a negative frequency fᵣ<0, which is practically immeasurable, is theoretically received. Since the direct measurement of a negative frequency is not practical, a quadrature receiver is used in which the negative spectrum component of receive signal fᵣ is ascertainable due to the phase relation between in-phase signal I and quadrature signal Q. When detecting a negative receive frequency fᵣ<0, the phase between in-phase signal I and quadrature signal Q changes its sign. This sign change is detected by phase evaluation device 12, after which a safety means 13 or a safety function 13 is activatable by the output signal of phase evaluation device 12.

FIG. 2 shows an example embodiment which is largely identical to the one shown in FIG. 1, but additionally includes a controller 14. In particular, when using multiple safety means or multiple safety functions, a separate time period t_{TC} being required for each safety means or safety function 13, during which the safety means must be activated prior to the calculated collision, it is practical to alternately vary the ramp slope in such a way that time periods t_{TC} are set. For this purpose, a control device 14 is provided which outputs to oscillator 2 a control signal via which oscillator 2 is variable with respect to the ramp slope. In addition, controller 14 outputs an output signal to safety means or safety function 13, this signal providing safety means or safety function 13 with the activation period until collision t_{TC} which is currently set in oscillator 2 and is evaluated with regard to the phase in Block 12.

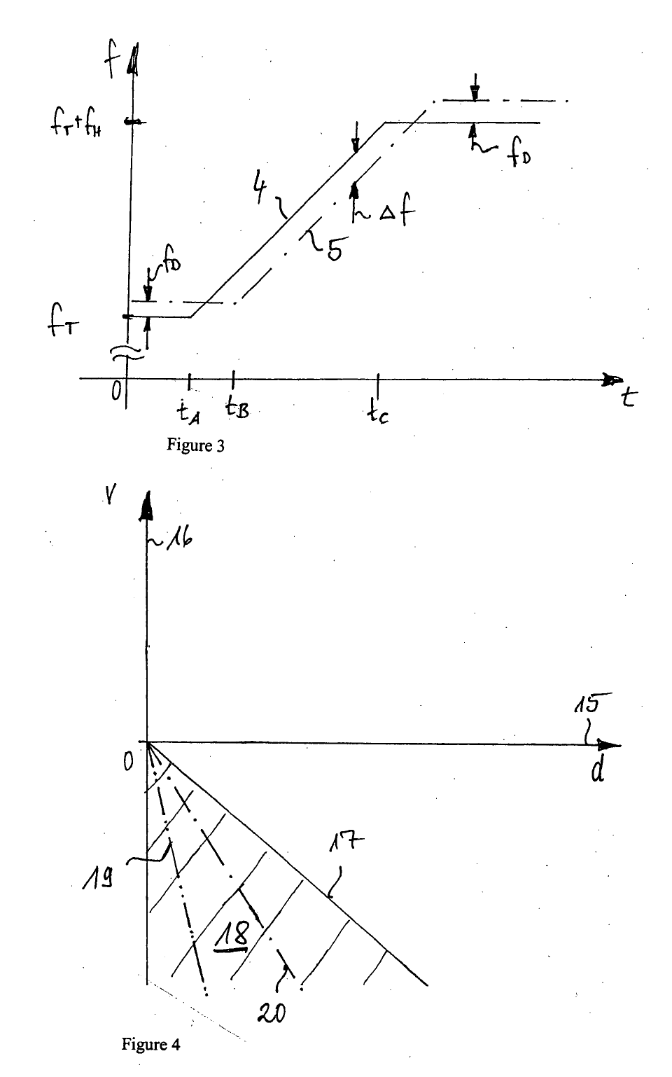

FIG. 3 shows a frequency-time diagram in which a frequency ramp of FMCW-modulated transmit signal 4 is illustrated as an example. Receive signal 5 is also shown, which is shifted in relation to transmit signal 4 as a result of the Doppler effect and propagation time. Transmit signal 4 has one or more ramps, these ramps each being able to have different slopes. For example, these ramps may alternately be rising and falling ramps or, for example, may include only consecutively rising frequency ramps having different slopes between which the frequency always returns to the initial frequency. During the time period of t=0 to t=t_{A}, a microwave signal is transmitted at carrier frequency fₜ. In the period between time t=t_{A} and time t=t_{C}, the transmit frequency rises to a value of fₜ+f_{H}, starting at carrier frequency fₜ, this value increasing by frequency shift f_{H} in relation to carrier frequency fₜ. The frequency slope of this ramp may be calculated as

$$“ Slope ” = \frac{{f}_{H}}{( {t}_{C} - {t}_{A} )} ,$$

which was also specified as the “Slope” variable in Equation 4. After time t=t_{C}, the frequency remains at a constant frequency value of fₜ+f_{H} and may thereafter either drop back to value fₜ, for example via a falling frequency ramp, or provide a frequency jump to a value of fₜ, after which a new frequency ramp rises. Receive signal 5, which was reflected back by a preceding object as a result of a reflection of send signal 4, is time-shifted with regard to transmit signal 4 due to the signal propagation time, the time shift having a value of t_{B}-t_{A} in the illustrated example. Due to this propagation time, transmit signal 4 has a higher frequency than receive signal 5 at a time t, since the transmit signal already has a higher instantaneous frequency as a result of the rising frequency ramp. The movement of the preceding object by which transmit signal 14 is reflected produces a Doppler shift by a value of f_{D}, which causes receive signal 5 to be shifted relative to transmit signal 4 by value f_{D} in the direction of positive frequencies. During the time period of a rising frequency ramp, for example during the time period between t=t_{A} and t=t_{C}, this yields a frequency shift Δf of receive signal 5 in relation to transmit signal 4 as a result of Doppler shift f_{D} as well as a frequency variation f_{LZ}, due to the signal propagation time and continuously rising frequency ramp. If, as shown in Equation 4, a carrier frequency fₜ and a ramp slope

$$\frac{{f}_{H}}{( {t}_{C} - {t}_{A} )}$$

are selected, making it possible to ascertain a collision within time period t_{TC}, this results in the activation range of safety means or safety function 13, as shown in a relative velocity distance diagram in FIG. 4.

FIG. 4 shows a diagram in which distance d of the host vehicle from the vehicle traveling ahead is plotted on abscissa 15 and relative velocity v is plotted on ordinate 16, which may assume both positive and negative values, depending on whether the vehicle traveling ahead is moving faster or slower than the host vehicle. If, for example, t_{TC}=0.3 seconds is set in equation 4 for time period t_{TC} within which a collision is detectable by a negative frequency, combinations of relative velocity v and distance d are obtained in which a collision is about to occur during future time period t=t_{TC}, provided that the vehicle is traveling at instantaneous relative velocity v, based on current distance d. This combination of relative velocity v and distance d is illustrated by way of example by line 17, which limits an area 18 including the relative velocity-distance combinations in which a collision is about to occur during future time period t_{TC} at a constant relative velocity, based on instantaneous distance d.

If a shorter time period, by which the safety means or safety function must be activated prior to the collision, is specified for activating safety means 13 or a safety function, it being possible to select, for example t_{TC}=0.2 seconds or 0.1 seconds for this time period, the relative velocity-distance diagram in FIG. 4 shows an activation threshold 19 or 20, activation thresholds being illustrated for any t_{TC}>0 seconds in the relative velocity-distance diagram in FIG. 4 as half lines 17, 19, 20 which begin in the coordinate origin and run in the quadrant, where v<0 and d>0. In this case, activation threshold 17 represents by way of example a time period t_{TC}=0.3 seconds until collision; activation threshold 20 represents by way of example time period t_{TC}=0.2 seconds; and half line 19 represents by way of example the activation threshold for t_{TC}=0.1 seconds. The activation ranges for these activation thresholds 19, 20 are derived in a manner similar to that of activation range 18, which belongs to activation threshold 17, in that the activation range is limited in each case by coordinate semi-axis v<0 and the half lines of activation threshold 17, 19, 20. A detected preceding object, which may be illustrated within activation range 18 in the relative velocity-distance diagram in FIG. 4, thus generates, at a suitably selected transmit frequency fₜ and a suitably selected frequency slope “Slope” as receive frequency fᵣ, a negative frequency which is detectable due to its phase relation between the in-phase signal and the quadrature signal. A safety means or a safety function 13 may be activated as a function of the detection of a phase relation of this type.

1-15. (canceled)

16. A device for detecting a pending collision between a host vehicle and a preceding object within a selected future time period, comprising:
a transceiver unit for transmitting electromagnetic radiation and for receiving reflected electromagnetic radiation from the preceding object, wherein the transmitted electromagnetic radiation is FMCW-modulated, and wherein a slope of a frequency ramp of the transmitted electromagnetic radiation is determined as a function of a transmitted frequency and the selected future time period, and wherein a pending collision within the selected future time period is detected if a negative received frequency is detected.

17. The device as recited in claim 16, wherein the selected future time period is a time period in which at least one of a safety unit and a safety function is to be activated, prior to time of the detected pending collision.

18. The device as recited in claim 17, wherein a quadrature receiver is provided to detect negative frequencies.

19. The device as recited in claim 18, wherein the quadrature receiver includes a phase comparator which uses a phase relationship between an in-phase signal and a quadrature signal to determine whether the received frequency is a positive frequency or a negative frequency.

20. The device as recited in claim 17, wherein the at least one of a safety unit and a safety function is activated when a negative received frequency is detected.

21. The device as recited in claim 18, wherein the at least one of the safety unit and the safety function includes at least one of: a) an automatic vehicle deceleration; b) an automatic steering intervention; and c) an occupant restraint system.

22. The device as recited in claim 17, wherein the slope of the frequency ramp of the transmitted electromagnetic radiation is selected to activate the at least one of the safety unit and the safety function by at least a stipulated time period prior to time of the detected pending collision.

23. The device as recited in claim 17, wherein the transmitted electromagnetic radiation and the received reflected electromagnetic radiation are one of a microwave radiation and a laser radiation.

24. A method for detecting a pending collision between a host vehicle and a preceding object within a selected future time period, comprising:
transmitting electromagnetic radiation and receiving reflected electromagnetic radiation from the preceding object, wherein the transmitted electromagnetic radiation is FMCW-modulated, and wherein a slope of a frequency ramp of the transmitted electromagnetic radiation is determined as a function of a transmitted frequency and the selected future time period; and
detecting a pending collision within the selected future time period when a negative received frequency is detected.

25. The method as recited in claim 24, wherein the selected future time period is the time period in which at least one of a safety unit and a safety function is to be activated, prior to time of the detected pending collision.

26. The method as recited in claim 25, wherein the received signals are supplied to a quadrature receiver to detect a negative received frequency.

27. The method as recited in claim 26, wherein a phase relationship between an in-phase signal and a quadrature signal is used to determine, via a phase comparator, whether the received frequency is a positive or a negative frequency.

28. The method as recited in claim 25, wherein the at least one of a safety unit and a safety function is activated when a negative received frequency is detected.

29. The method as recited in claim 28, wherein the at least one of the safety unit and the safety function includes at least one of: a) an automatic vehicle deceleration; b) an automatic steering intervention; and c) an occupant restraint system.

30. The method as recited in claim 25, wherein the slope of the frequency ramp of the transmitted electromagnetic radiation is selected to activate the at least one of the safety unit and the safety function by at least a stipulated time period prior to time of the detected pending collision.
